(19) United States
(12) Patent Application Publication
(10) Pub. No.: US 2014/0285688 A1
(43) Pub. Date: Sep. 25, 2014

(54) OPTICAL SYSTEM OF ELECTRICAL EQUIPMENT, ELECTRICAL EQUIPMENT, AND OPTICAL FUNCTION COMPLEMENTARY PROCESSING CIRCUIT

(71) Applicant: Kabushiki Kaisha Toshiba, Minato-ku (JP)

(72) Inventors: Takayuki OGASAHARA, Yokohama-shi (JP); Ninao Sato, Mitaka-shi (JP); Kazuhiro Nagata, Yokohama-shi (JP); Katsuo Iwata, Yokohama-shi (JP)

(73) Assignee: Kabushiki Kaisha Toshiba, Minato-ku (JP)

(21) Appl. No.: 14/090,441

(22) Filed: Nov. 26, 2013

(30) Foreign Application Priority Data
Mar. 19, 2013 (JP) 2013-056843

(51) Int. Cl. H04N 5/357; H04N 9/64

(52) U.S. Cl. CPC H04N 5/357; H04N 9/646
USPC 348/240.99; 348/222.1

(57) ABSTRACT

According to one embodiment, an optical system of electrical equipment includes an imaging optical system and an optical function complementary processing circuit. The imaging optical system captures light from a subject. The imaging optical system forms a subject image. The electrical equipment includes the imaging optical system, a solid state imaging device, and an image signal processing circuit. The solid state imaging device images the subject image. The solid state imaging device outputs an image signal. The image signal processing circuit executes processing of the image signal. The optical function complementary processing circuit is provided in a processing path between the solid state imaging device and the image signal processing circuit. The optical function complementary processing circuit executes processing for complementing functions of the imaging optical system regarding formation of the subject image.

### CROSS-REFERENCE TO RELATED APPLICATIONS

This application is based upon and claims the benefit of priority from Japanese Patent Application No. 2013-056843, filed on Mar. 19, 2013; the entire contents of which are incorporated herein by reference.

### FIELD

Embodiments described herein relate generally to an optical system of electrical equipment, electrical equipment, and an optical function complementary processing circuit.

### BACKGROUND

In order to mount a camera module on a portable terminal, such as a smart phone, thinning of the camera module has been strongly requested. Miniaturization of a pixel in an image sensor has been promoted as a response to the thinning of a camera module and an increase in number of pixels. Because of limited resolving power of a lens, a request of low cost, and the like in an imaging optical system, performance of the lens tends to be lower with respect to the performance of the image sensor. As the pixel is miniaturized in the camera module, the resolving power of the lens is reduced with respect to resolution of the image sensor. Accordingly, reduction of photodetection sensitivity and influence of diffraction limit have become problems.

In order to realize the thinning of the camera module, it is desirable that a distance between the lens and the image sensor be as short as possible. It is considered that a high refractive index material is used as a material of the lens to shorten the distance between the lens and the image sensor. By reducing the number of lenses configuring the imaging optical system in the camera module, it is possible to make the imaging optical system itself short and thin and to reduce the cost thereof.

In the camera module, it is difficult to shorten the distance between the lens and the image sensor greatly by simply replacing a conventional lens with a lens formed of a high refractive index material. When a glass, which is a high refractive index material, for example, is used as the lens material, the camera module has problems of an increase in the cost of material and an increase in weight of the imaging optical system. Due to the increase in the weight of the imaging optical system, the camera module has an additional problem of an increase in the cost of an actuator, which drives the imaging optical system. In the camera module, if the number of lenses is reduced, various aberrations and reduction of resolving power of the imaging optical system become conspicuous, and it is difficult to obtain a good optical performance. Further, in the camera module, since the resolving power of the imaging optical system is reduced, it is difficult to improve photodetection sensitivity.

### BRIEF DESCRIPTION OF THE DRAWINGS

FIG. 1 is a block diagram illustrating a schematic structure of a digital camera serving as electrical equipment according to an embodiment;

FIG. 2 is a block diagram illustrating a schematic structure of a solid state imaging device;

FIG. 3 is a block diagram illustrating a structure of an optical function complementary processing circuit; and

FIG. 4 is a diagram explaining about processing in the optical function complementary processing circuit.

### DETAILED DESCRIPTION

In general, according to one embodiment, an optical system of electrical equipment includes an imaging optical system and an optical function complementary processing circuit. The imaging optical system captures light from a subject. The imaging optical system forms a subject image. The electrical equipment includes the imaging optical system, a solid state imaging device, and an image signal processing circuit. The solid state imaging device images the subject image. The solid state imaging device outputs an image signal. The image signal processing circuit executes processing of the image signal. The optical function complementary processing circuit is provided in a processing path between the solid state imaging device and the image signal processing circuit. The optical function complementary processing circuit executes processing for complementing functions of the imaging optical system regarding formation of the subject image.

Exemplary embodiments of an optical system of electrical equipment, electrical equipment, and an optical function complementary processing circuit will be explained below in detail with reference to the accompanying drawings. The present invention is not limited to the following embodiments.

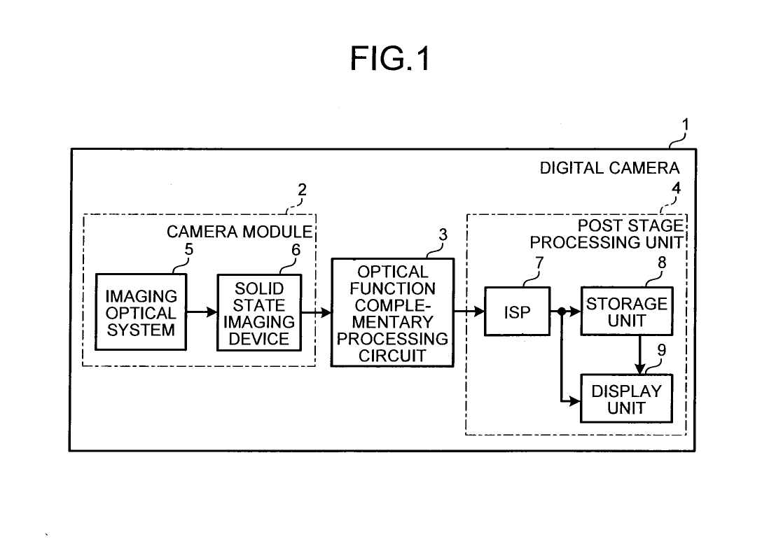

FIG. 1 is a block diagram illustrating a schematic structure of a digital camera serving as electrical equipment according to the embodiment. A digital camera 1 has a camera module 2, an optical function complementary processing circuit 3, and a post stage processing unit 4.

The camera module 2 has an imaging optical system 5 and a solid state imaging device 6. The imaging optical system 5 captures light from a subject and forms a subject image. The imaging optical system 5 includes a plurality of lenses. The solid state imaging device 6 images the subject image and outputs an image signal. In addition to the digital camera 1, the camera module 2 is applicable to electrical equipment, e.g., a camera-equipped portable terminal.

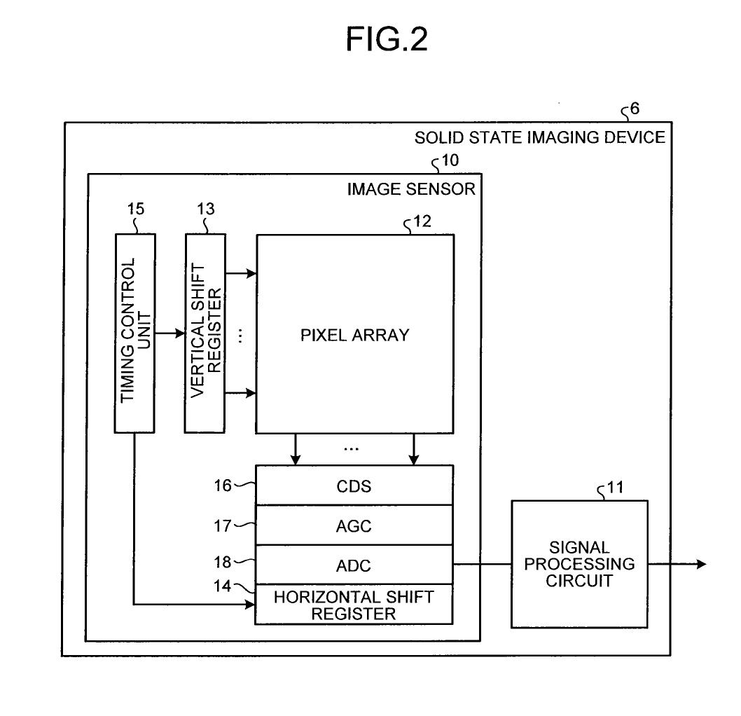

FIG. 2 is a block diagram illustrating a schematic structure of the solid state imaging device. The solid state imaging device 6 includes a signal processing circuit 11 and an image sensor 10 serving as an imaging element. The image sensor 10, for example, is a complementary metal oxide semiconductor (CMOS) image sensor. In addition to the CMOS image sensor, the image sensor 10 may be a charge coupled device (CCD).

The image sensor 10 has a pixel array 12, a vertical shift register 13, a horizontal shift register 14, a timing control unit 15, a correlative double sampling unit (CDS) 16, an automatic gain control unit (AGC) 17, and an analog to digital converting unit (ADC) 18.

The pixel array 12 is provided in an imaging region of the image sensor 10. The pixel array 12 is formed of a plurality of pixels which is arranged in an array shape in a horizontal direction (row direction) and a vertical direction (column direction). Each pixel includes a photodiode serving as a photoelectric conversion element. The pixel array 12 generates a signal charge according to an amount of incident light on each pixel.

The timing control unit 15 supplies a timing signal indicating a timing, at which a signal from each pixel of the pixel array 12 is read out, to the vertical shift register 13 and the horizontal shift register 14. The vertical shift register 13 selects pixels within the pixel array 12 at each row according to a vertical synchronizing signal, which is a timing signal from the timing control unit 15. The vertical shift register 13 outputs a readout signal to each pixel in the selected row.

The pixel, to which the readout signal has been input from the vertical shift register 13, outputs an accumulated signal charge according to an amount of incident light. The pixel array 12 outputs a signal from the pixel to the CDS 16 via a vertical signal line. The vertical shift register 13 functions a row selecting circuit that selects a row from which the signal charges are to be read in the pixel array 12.

The CDS 16 performs correlative double sampling processing for decreasing a fixed pattern noise on the signal from the pixel array 12. The AGC 17 amplifies the signal subjected to the correlative double sampling in the CDS 16. The ADC 18 converts the signal subjected to the amplification in the AGC 17 from an analog form to a digital form. The horizontal shift register 14 sequentially reads out the signal converted into the digital form in the ADC 18 according to a horizontal synchronizing signal serving as a timing signal from the timing control unit 15.

The signal processing circuit 11 executes various signals processing for the digital image signal read out by the horizontal shift register 14. The signal processing circuit 11, for example, executes signal processing, such as defect correction, noise reduction, shading correction, and white balance adjustment. The solid state imaging device 6 outputs a RAW image signal subjected to the signal processing in the signal processing circuit 11.

The optical function complementary processing circuit 3 executes processing for complementing functions of the imaging optical system 5 regarding formation of a subject image. The optical function complementary processing circuit 3 outputs the RAW image signal subjected to the processing for complementing the functions of the imaging optical system 5. The imaging optical system 5 and the optical function complementary processing circuit 3 constitute an optical system of the digital camera 1.

The optical function complementary processing circuit 3 is configured, for example, as a companion chip. The optical function complementary processing circuit 3 is provided on a circuit substrate different from any of the signal processing circuit 11 of the solid state imaging device 6 and an image signal processor (ISP) 7 of the post stage processing unit 4. It should be noted that the optical function complementary processing circuit 3 may be disposed at any position in the digital camera 1. The optical function complementary processing circuit 3 may be provided, for example, in the solid state imaging device 6.

The post stage processing unit 4 has the ISP 7, a storage unit 8, and a display unit 9. The ISP 7 is an image signal processing circuit. The ISP 7 executes signal processing of the RAW image signal obtained by imaging in the solid state imaging device 6. The optical function complementary processing circuit 3 is provided in a processing path between the signal processing circuit 11 of the solid state imaging device 6 and the ISP 7.

The ISP 7 executes a pixel interpolation processing (demosaicing) or the like for the RAW image. The ISP 7 generates a sensitivity level value of a shortage color component by the pixel interpolation processing for the RAW image signal. By the pixel interpolation processing for the RAW image signal subjected to the processing in the optical function complementary processing circuit 3, the ISP 7 synthesizes a color bitmap image. The ISP 7 performs various corrections for improving image quality to the demosaiced color image.

The storage unit 8 stores the image subjected to the signal processing in the ISP 7. The storage unit 8 outputs an image signal to the display unit 9 according to a user's operation or the like. The display unit 9 displays an image according to the image signal input from the ISP 7 or the storage unit 8. The display unit 9, for example, is a liquid crystal display.

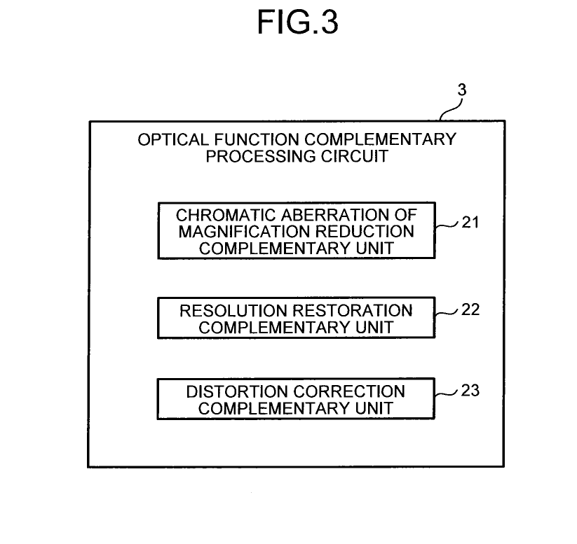

FIG. 3 is a block diagram illustrating a structure of the optical function complementary processing circuit. The optical function complementary processing circuit 3 has a chromatic aberration of magnification reduction complementary unit 21, a resolution restoration complementary unit 22, and a distortion correction complementary unit 23.

The lenses configuring the imaging optical system 5 generate a chromatic aberration of magnification. The chromatic aberration of magnification is caused by changes in the magnification of an image depending on a wavelength of light. The imaging optical system 5 includes a function of reducing the chromatic aberration of magnification caused by characteristics of the lenses. The chromatic aberration of magnification reduction complementary unit 21 executes signal processing, which complements the function of reducing the chromatic aberration of magnification by the imaging optical system 5, for the RAW image signal.

The lenses configuring the imaging optical system 5 generate an axial chromatic aberration. The axial chromatic aberration is caused by changes in a refractive index depending on a wavelength of light. The imaging optical system 5 includes a resolution restoration function for reducing the axial chromatic aberration caused by the characteristics of the lenses. The resolution restoration complementary unit 22 executes signal processing, which complements the resolution restoration function by the imaging optical system 5, for the RAW image signal.

The lenses configuring the imaging optical system 5 generate a distortion aberration. The distortion aberration is a phenomenon of deforming an image. A degree in which a subject image is distorted increases with distance from a center of a screen. The imaging optical system 5 includes a function of correcting the distortion of the subject image caused by the characteristics of the lenses. The distortion correction complementary unit 23 executes signal processing, which complements the distortion correction function by the imaging optical system 5.

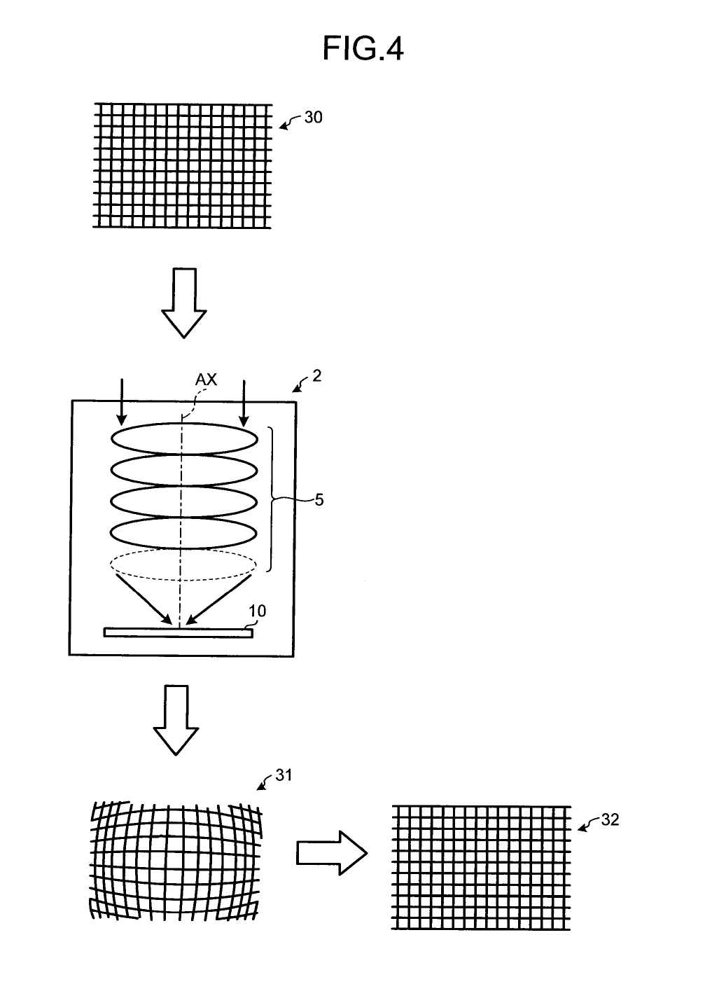

FIG. 4 is a diagram explaining about processing in the optical function complementary processing circuit. In order to realize the thinning of the camera module 2, it is desirable that a distance between the imaging optical system 5 and the image sensor 10 be as short as possible. It is considered that a high refractive index material is used as a material of the lens to shorten the distance between the imaging optical system 5 and the image sensor 10. In the camera module 2, by reducing the number of lenses configuring the imaging optical system 5, the imaging optical system 5 itself can be shortened, and the cost thereof can be reduced. On the other hand, the imaging optical system 5 can suppress various aberrations by increasing the number of lenses.

In the camera module 2, suppose the imaging optical system 5 is formed of five lenses to obtain desirable optical characteristics from the functions of the imaging optical system 5. The imaging optical system 5 formed of five lenses, for example, includes functions which can sufficiently perform reduction of the chromatic aberration of magnification, resolution restoration, and distortion correction. In this case, suppose, for example, an attempt is made to change the number of lenses of the imaging optical system 5 from five to four.

In the camera module 2, by reducing the number of lenses configuring the imaging optical system 5, it is possible to make the imaging optical system 5 itself short and thin and to reduce the cost thereof. However, the reduction of the number of lenses makes it difficult for the imaging optical system 5 to suppress various aberrations. When this imaging optical system 5 is used to image a subject 30, a chromatic aberration of magnification, an axial chromatic aberration, and a distortion are noticeably generated in a subject image 31 obtained by the image sensor 10. In the camera module 2, since the aberrations in the imaging optical system 5 remain, it is difficult to obtain good optical characteristics.

In the optical system of the present embodiment, since the number of lenses in the imaging optical system 5 is reduced for thinning of the camera module 2, deterioration of optical performance, in which the imaging optical system 5 alone cannot absorb, is complemented by the optical function complementary processing circuit 3. In a case where the imaging optical system 5 having a lens structure capable of obtaining sufficient optical characteristics in normal photography is assumed, the optical function complementary processing circuit 3 performs a part of the functions of the lenses configuring the imaging optical system 5.

In the optical system of the present embodiment, instead of providing the optical function complementary processing circuit 3 which complements the functions of the imaging optical system 5 regarding the formation of a subject image, the number of lenses in the imaging optical system 5 can be reduced. The imaging optical system 5 of the present embodiment, for example, is formed of four lenses.

The chromatic aberration of magnification reduction complementary unit 21 complements a function of correcting deviation of an imaging point at each colored light in a direction perpendicular to an optical axis AX of the imaging optical system 5. The resolution restoration complementary unit 22 complements a function of correcting deviation of the imaging point in the optical axis AX direction of the imaging optical system 5. The distortion correction complementary unit 23 complements a function of correcting distortion of the subject image 31.

The digital camera 1 obtains a RAW image 32, in which reduction of chromatic aberration of magnification, resolution restoration, and distortion correction have been performed by the signal processing in the optical function complementary processing circuit 3. In the digital camera 1, by disposing the optical function complementary processing circuit 3 in the processing path between the solid state imaging device 6 and the ISP 7, the once deteriorated optical characteristics caused by the imaging optical system 5 can be improved at a pre-stage, such as demosaic processing, in the post stage processing unit 4.

The optical function complementary processing circuit 3 executes processing for complementing the optical characteristics of the imaging optical system 5 for the RAW image signal before being input to the ISP 7. In contrast to this, the ISP 7 of the post stage processing unit 4 performs various corrections for improving image quality for the demosaiced color image signal. In the present embodiment, the optical function complementary processing circuit 3 functions as a processing unit different from the ISP 7. Regardless of the deterioration of the optical characteristics in the imaging optical system 5, the ISP 7 capable of executing processing similar to conventional one can be used in the digital camera 1. For example, in a case where data is fit to a nonlinear function (fitting) as an operation in the optical function complementary processing circuit 3, a higher degree can be applied to the operation in the optical function complementary processing circuit 3 as compared with a case of an operation in the ISP 7.

Since the aberrations can be positively left in the imaging optical system 5, the digital camera 1 is capable of reducing a function load on the lenses of the imaging optical system 5. Since high functionalization of the lenses can be unnecessary, the imaging optical system 5 can relax accuracy required for the lenses. In the camera module 2, since the number of lenses in the imaging optical system 5 can be made small and the accuracy required for the lenses can be relaxed, the cost can be reduced.

In the optical system of the present embodiment, in addition to reducing the number of lenses in the imaging optical system 5, at least any one of the lenses in the imaging optical system 5 may be formed of a high refractive index and high dispersion material. In the digital camera 1, various aberrations, which may be caused by such change in the lens material, can be absorbed by the processing in the optical function complementary processing circuit 3.

When the imaging optical system 5, for example, includes four lenses, each lens material may be selected in such a manner that the first lens and the third lens from an incidence side have low refractive indices (e.g., n=1.5) and low dispersions and that the second lens and the fourth lens from the incidence side have high refractive indices (e.g., n=1.6) and high dispersions. In the imaging optical system 5, the fourth lens, which is located closest to the image sensor 10, of the four lenses serves as a lens formed of a high refractive index and high dispersion material. The camera module 2 can constitute the imaging optical system 5, in which more lenses are lenses formed of a high refractive index material than before. In this way, the camera module 2 can shorten a focal distance from the imaging optical system 5 to the image sensor 10.

In the camera module 2, since the number of lenses in the imaging optical system 5 is small, it is possible to reduce weight of the imaging optical system 5. In the camera module 2, due to the weight reduction of the imaging optical system 5, it is also possible to reduce a cost of an actuator driving the imaging optical system 5. In the imaging optical system 5, glass may be used for the high refractive index material serving as the lens material. In the camera module 2, the increase in weight by using the glass as the lens material can be offset to some extent by the decrease in weight by reducing the number of lenses in the imaging optical system 5. Further, in the camera module 2, the increase in cost by using the glass as the lens material can be offset to some extent by the decrease in cost by reducing the number of lenses in the imaging optical system 5.

According to the present embodiment, thinning of the camera module 2 can be realized by reducing the number of lenses constituting the imaging optical system 5 and using the lens formed of the high refractive index material. The optical function complementary processing circuit 3 complements the functions, in which the imaging optical system 5 cannot bear due to the thinning of the camera module 2. The digital camera 1 makes it possible to suppress various aberrations and maintain the resolving power of the optical system with the processing of the optical function complementary processing circuit 3. Since the digital camera 1 is capable of maintaining the resolving power of the optical system, it is possible to improve the photodetection sensitivity.

As described above, the optical system of electrical equipment achieves effects in that the electrical equipment can be made thin and that good optical characteristics can be obtained. By the optical system having good optical performances, the digital camera 1 can obtain the RAW image 32 in which the aberrations and resolving power deterioration are suppressed.

It should be noted that the optical function complementary processing circuit 3 may include at least any one of the chromatic aberration of magnification reduction complementary unit 21, the resolution restoration complementary unit 22, and the distortion correction complementary unit 23. In this case as well, the optical system of the electrical equipment can obtain effects in that the electrical equipment is made thin and that good optical characteristics are obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical system of electrical equipment including an imaging optical system which captures light from a subject and forms a subject image, a solid state imaging device which images the subject image and outputs an image signal, and an image signal processing circuit which executes processing of the image signal, comprising:
the imaging optical system; and
an optical function complementary processing circuit provided in a processing path between the solid state imaging device and the image signal processing circuit and executing processing for complementing functions regarding formation of the subject image by the imaging optical system.

2. The optical system of electrical equipment according to claim 1, wherein the optical function complementary processing circuit has a chromatic aberration of magnification reduction complementary unit which complements a function of reducing a chromatic aberration of magnification by the imaging optical system.

3. The optical system of electrical equipment according to claim 1, wherein the optical function complementary processing circuit has a resolution restoration complementary unit which complements a resolution restoration function of the subject image by the imaging optical system.

4. The optical system of electrical equipment according to claim 1, wherein the optical function complementary processing circuit has a distortion correction complementary unit which complements a distortion correction function of the subject image by the imaging optical system.

5. The optical system of electrical equipment according to claim 1, wherein the optical function complementary processing circuit has:
a chromatic aberration of magnification reduction complementary unit which complements a function of reducing a chromatic aberration of magnification by the imaging optical system;
a resolution restoration complementary unit which complements a resolution restoration function of the subject image by the imaging optical system; and
a distortion correction complementary unit which complements a distortion correction function of the subject image by the imaging optical system.

6. The optical system of electrical equipment according to claim 1, wherein the optical function complementary processing circuit outputs a RAW image signal subjected to processing for complementing the functions of the imaging optical system.

7. The optical system of electrical equipment according to claim 1, wherein the optical function complementary processing circuit is configured as a companion chip.

8. Electrical equipment, comprising:
an optical system including an imaging optical system which captures light from a subject and forms a subject image;
a solid state imaging device which images the subject image and outputs an image signal; and
an image signal processing circuit which executes processing of the image signal,
wherein the optical system further includes an optical function complementary processing circuit which executes processing for complementing functions regarding formation of the subject image by the imaging optical system, and
the optical function complementary processing circuit is provided in a processing path between the solid state imaging device and the image signal processing circuit.

9. The electrical equipment according to claim 8, wherein the optical function complementary processing circuit has a chromatic aberration of magnification reduction complementary unit which complements a function of reducing a chromatic aberration of magnification by the imaging optical system.

10. The electrical equipment according to claim 8, wherein the optical function complementary processing circuit has a resolution restoration complementary unit which complements a resolution restoration function of the subject image by the imaging optical system.

11. The electrical equipment according to claim 8, wherein the optical function complementary processing circuit has a distortion correction complementary unit which complements a distortion correction function of the subject image by the imaging optical system.

12. The electrical equipment according to claim 8, wherein the optical function complementary processing circuit has:
a chromatic aberration of magnification reduction complementary unit which complements a function of reducing a chromatic aberration of magnification by the imaging optical system;
a resolution restoration complementary unit which complements a resolution restoration function of the subject image by the imaging optical system; and
a distortion correction complementary unit which complements a distortion correction function of the subject image by the imaging optical system.

13. The electrical equipment according to claim 8, wherein the imaging optical system is formed by including a plurality of lenses, and
any one of the plurality of lenses is formed of a high refractive index and high dispersion material as compared with materials of other lenses of the plurality of lenses.

14. The electrical equipment according to claim 13, wherein the lens, which is located closest to an image sensor in the solid state imaging device, of the plurality of lenses is formed of the high refractive index and high dispersion material as compared with the materials of the other lenses.

15. An optical function complementary processing circuit provided in a processing path between a solid state imaging device and an image signal processing circuit and executing processing for complementing functions regarding formation of a subject image by an imaging optical system, comprising:
a chromatic aberration of magnification reduction complementary unit which complements a function of reducing a chromatic aberration of magnification by the imaging optical system;
a resolution restoration complementary unit which complements a resolution restoration function of the subject image by the imaging optical system; and
a distortion correction complementary unit which complements a distortion correction function of the subject image by the imaging optical system.

16. The optical function complementary processing circuit according to claim 15, wherein a RAW image signal subjected to processing for complementing the functions of the imaging optical system is output.
